(19) United States
(12) Patent Application Publication
(10) Pub. No.: US 2012/0118313 A1
(43) Pub. Date: May 17, 2012

(54) Extra hand lotion applicator

(76) Inventor: Tabatha Forgue, South River, NJ (US)

(21) Appl. No.: 13/317,874

(22) Filed: Oct. 31, 2011

Related U.S. Application Data
(60) Provisional application No. 61/456,048, filed on Oct. 29, 2010.

(51) Int. Cl. A45D 40/26; B05C 17/00

(52) U.S. Cl. 132/200; 401/8

(57) ABSTRACT

A lotion applicator is provided comprising a specially designed applicator comprised of an elongated panel manufactured of malleable plastic material. Elongate and rectangular in shape, the Extra Hand measures approximately twenty-eight inches in length and two and one-half inches in width. For practical purposes, positioned at each end of the unit is an integrated, nonskid strap-like handle, with which the user easily controls the device. Thus, the user comfortably grips both ends of the unit and slides the panel up and down the back or other hard to reach areas, evenly applying lotion to their body. The Extra Hand is produced in a number of striking colors or printed designs.

### CLAIM OF PRIORITY

This patent application claims priority under 35 USC 119 (e) (1) from U.S. Provisional Patent Application Ser. No. 61/456,048 filed Oct. 29, 2010, of common inventorship herewith entitled, “Extra Hand Lotion Applicator.”

### FIELD OF THE INVENTION

The present invention pertains to the field of skin care devices and more specifically to the field of skin care applicator devices.

### BACKGROUND OF THE INVENTION

The prior art has put forth several designs for skin care applicator devices. Among these are:

U.S. Pat. No. 3,870,419 to George H. Sage describes a back scrubber, massager and lotion applicator. A resilient body having opposed faces connected together by a wall to form a soap receiving chamber is providing comprising opposed straps attached to the body form a handhold for enabling a person to scrub his back with the body portion.

U.S. Pat. No. 5,251,990 to Elizabeth C. Vought et al describes a method of applying skin products using an elongated strip. An applicator is provided for use in placing skin products on a person's body, particularly the recessed areas of the back. The applicator comprises an elongated rectangular strip of flexible material having finger holes at each end.

U.S. Pat. No. 5,360,111 to Steven E. Arispe describes a compact lotion applicator for tanning lotions and the like wherein the applicator is removably attached to the end of the device.

None of these prior art references describe the present invention.

### SUMMARY OF THE INVENTION

It is an object of the present invention to provide an improved skin care applicator device.

### BRIEF DESCRIPTION OF THE DRAWINGS

FIG. 1 is an elevational angled perspective view of the device of the present invention.

FIG. 2 is a close-up elevational angled perspective view of a portion of the device of the present invention.

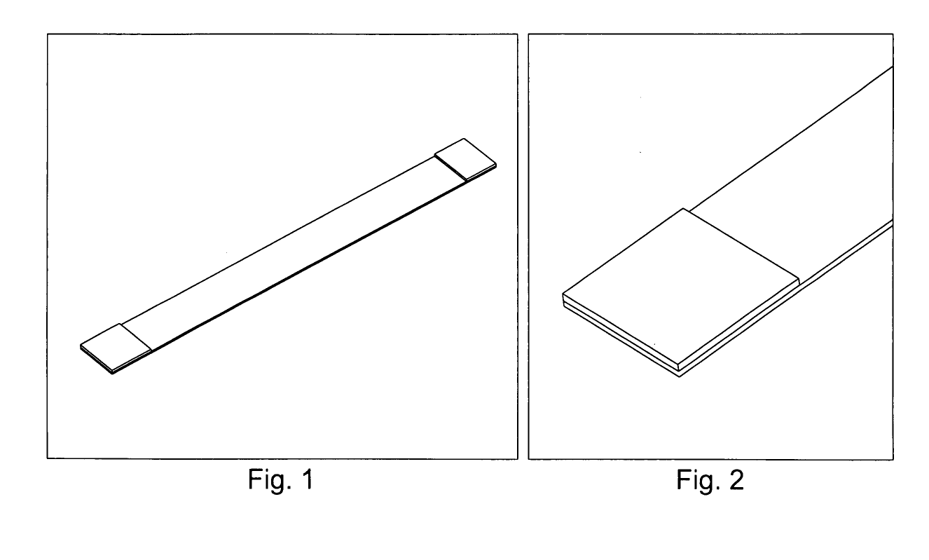

### DETAILED DESCRIPTION OF THE INVENTION

The present invention, hereinafter referred as the Extra Hand, is a specially designed applicator comprised of an elongated panel manufactured of malleable plastic material. Elongate and rectangular in shape, the Extra Hand measures approximately twenty-eight inches in length and two and one-half inches in width. For practical purposes, positioned at each end of the unit is an integrated, nonskid strap-like handle, with which the user easily controls the device. Thus, the user comfortably grips both ends of the unit and slides the panel up and down the back or other hard to reach areas, evenly applying lotion to their body. The Extra Hand is produced in a number of striking colors or printed designs.

Use of the Extra Hand is very simple and straight forward. First, the user applies their favorite lotion, moisturizer or medicinal ointment to the surface of the Extra Hand. The user then simply wraps the unit behind their back or other designated area of the body. Gripping each end of the Extra Hand via the integrated handles, the user then glides the unit back and forth over their body, thus evenly applying the lotion as desired.

The Extra Hand is an innovative product invention which offers consumers a number of significant benefits and advantages. Foremost, the Extra Hand provides consumers a simple and efficient means of applying moisturizers and lotion to hard to reach areas of the body. Ensuring thorough coverage and an even application, consumers appreciate that with the Extra Hand they apply their favorite lotions, moisturizers and sun blocks to the back, shoulders, thighs and other areas that are typically difficult to access without assistance. Ideal for use with medicinal lotions, creams, and topical ointments, the Extra Hand proves particularly useful to those who suffer skin conditions such as eczema, acne and dry skin, enabling these consumers to apply treatments to affected areas without the embarrassment and discomfort of asking for help. Additionally, individuals with limited mobility, such as seniors with arthritis, back pain sufferers and athletes recovering from injury find the Extra Hand especially helpful. Offering sun worshippers and beach goers a simple means of protecting themselves from overexposure to the sun, the Extra Hand also proves valuable to outdoor enthusiasts. Allowing those who enjoy spending time in the sun to evenly apply lotion to their backs and legs, use of the Extra Hand could ensure ample UV protection. A practical alternative to awkwardly stretching to reach these areas, or in worse case scenarios, leaving, this skin completely exposed, the Extra Hand enables consumers to apply their lotion in a comfortable manner. Machine washable, the Extra Hand withstands years of repeated use.

Practical and unique, the Extra Hand offers consumers a simple and efficient means of applying lotion to their bodies. Enabling the user to apply tanning lotions, moisturizers, medicinal ointments and creams in a neat and efficient manner, this cleverly designed applicator proves an invaluable accessory in any home.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved skin care applicator device, comprising:
an elongated panel essentially rectangular in shape, wherein two integrated, nonskid strap-like handles with which the user easily controls the device are positioned at each end of the device.

2. The device of claim 1 produced in a number of striking colors or printed designs.

3. The device of claim 1 manufactured of malleable plastic material.

4. The device of claim 1 which measures approximately twenty-eight inches in length and two and one-half inches in width

5. A method of applying lotion to hard to reach parts of the body wherein the user applies lotion to the middle of the device and the user comfortably grips both ends of the unit with each hand and slides the panel up and down the back or other hard to reach areas, evenly applying lotion to their body.
